(19) United States
(12) Patent Application Publication
(10) Pub. No.: US 2006/0156934 A1
(43) Pub. Date: Jul. 20, 2006

(54) Rotary printing press

(75) Inventors: Dieter Arabin, Langgons-Cleeberg (DE); Dieter Bangel, Huttenberg-Rechtenbach (DE)

Correspondence Address: LERNER GREENBERG STEMER LLP, P O BOX 2480, HOLLYWOOD, FL, 33022-2480, US

(73) Assignee: Gallus Druckmaschinen AG

(21) Appl. No.: 11/384,632

(22) Filed: Mar. 20, 2006

Related U.S. Application Data
(63) Continuation of application No. PCT/EP04/10479, filed on Sep. 17, 2004.

(30) Foreign Application Priority Data
Sep. 19, 2003 (DE) 103 43 411.9

(51) Int. Cl. B41F 5/00

(52) U.S. Cl. 101/216

(57) ABSTRACT

A rotary printing press that is selectively usable for different printing technologies. The rotary printing press contains a printing platform that can receive a printing head for a standard flexographic printing process or a printing head for a silk-screen printing process. Therefore, different printing technologies can be realized with the same platform.

### CROSS-REFERENCE TO RELATED APPLICATION

This is a continuing application, under 35 U.S.C. §120, of copending international application No. PCT/EP2004/010479, filed Sep. 17, 2004, which designated the United States; this application also claims the priority, under 35 U.S.C. §119, of German patent application No. 103 43 411.9, filed Sep. 19, 2003; the prior applications are herewith incorporated by reference in their entirety.

### BACKGROUND OF THE INVENTION

### Field of the Invention

The invention relates to a rotary printing press that is selectively usable for different printing technologies.

Printing units for rotary printing presses that can be used either for the standard flexographic printing process or for the silk-screen printing process are known from the prior art.

Such prior art devices have the disadvantage that the printing units can be used either exclusively for flexographic printing or exclusively for silk-screen printing.

The invention is based on the technical problem of providing a rotary printing press that can be used both for silk-screen printing and for standard flexographic printing.

### SUMMARY OF THE INVENTION

It is accordingly an object of the invention to provide a rotary printing press which overcomes the above-mentioned disadvantages of the prior art devices of this general type, in which different functions (i.e. different printing technologies) are realized with one and the same platform.

With the foregoing and other objects in view there is provided, in accordance with the invention, a rotary printing press selectively usable for different printing technologies. The rotary printing press contains a printing platform, a printing head, being either a standard flexographic printing process print head or a silk-screen printing process print head, inserted into the printing platform, and bearings including a gear side bearing and a work side bearing for receiving a printing cylinder. The work side bearing is configured for releasing the printing cylinder and is movable out of an operating area independently of the gear side bearing.

The solution to the technical problem is a rotary printing press containing a printing platform that can receive either a standard flexographic printing head or a silk-screen printing head.

The rotary printing press according to the invention advantageously includes a gear side bearing and a work side bearing for a printing cylinder. For an easy exchange or removal of the printing cylinder, the work side bearing releases the printing cylinder and is configured to be movable out of the operating (i.e. printing) range.

According to a preferred embodiment, the work side bearing is disposed in a front plate.

After releasing the bearing, the front plate can be automatically lowered.

In accordance with another advantageous embodiment of the invention, the front plate with the work side bearing and the gear side bearing are movable out of the printing position.

Before, during and after such a motion of the bearings, the work side bearing of the front plate releases the printing cylinder. Subsequently, the work side bearing with the front plate moves out of the operating range, preferably downwards.

This provides easy access to the printing cylinder so that the latter can easily be removed.

More precisely, the cylinder can be taken out of the press from the front of the press. Thus a printing cylinder change or removal is very easy.

In accordance with the prior art, printing cylinders are removed from rotary printing presses from the upper side. It is very difficult for an operator standing in front of the press to lift up the relatively heavy printing cylinder before he can remove the cylinder from the press.

Advantageously, the paths of the bearing motions are linear. This ensures a high degree of accuracy. In order to increase the accuracy even further, ball spindle drives are advantageously provided for moving the bearings and/or the front plate. The ball spindles are driven by positioning drives.

The printing cylinder can be changed in different ways. As a first variant, the entire printing cylinder with both of its bearings is moved upward. Subsequently, the work side bearing is released, and the front plate is moved downward.

The second variant is a simultaneous process. The work side bearing releases immediately, the rear bearing, i.e. the gear side bearing, is moved upward, and the front plate is moved downward.

In accordance with a preferred embodiment, the bearing mandrel of the work side bearing has already been released for reasons of security when both bearings move at the same time. If any controlling inaccuracy occurs, the printing cylinder is not bent at any time.

The rotary printing press is advantageously equipped with a further front plate that contains a work side bearing for an anilox roller. The front plate is also adjustable, preferably automatically, in such a manner that the work side bearing releases the anilox roller and moves out of the operation area. Thus the anilox roller, too, can be removed very easily.

The first step for changing the anilox roller is to release the anilox roller. Then the pin of the bearing is moved away. Subsequently, the bearing can be lowered either manually or automatically.

The specification of the paths for lowering the printing cylinder into the printing position after a printing cylinder change is made by inputting the diameter of the printing cylinder into the control system.

The substantial aspect of the invention is the motor-driven movement of the bearings.

Linear paths of movement are selected to attain a very high degree of accuracy.

The rotary printing press according to the invention provides an easy way of changing the printing roller and/or the anilox roller for different print jobs.

In addition, once the printing cylinder and the anilox roller have been removed, a printing head for a silk-screen printing process can be used in the rotary printing press according to the invention.

For this purpose, a drawer system is advantageously provided. The printing head for the silk-screen printing process is placed on the drawer system outside of the actual rotary printing press. This provides easy handling. The drawer system is then used to insert the printing head into the rotary printing press.

On the one hand, the drawer system receives the printing head for the silk-screen printing process. On the other hand, the drawer system receives the ink chamber for the standard flexographic printing process.

The rotary printing press according to invention is advantageously configured in such a way that individual drives are provided for driving the printing heads, whereas the transport rollers are driven by a main shaft.

However, it is also possible to provide individual drives for the transport rollers and/or to provide a common main shaft for driving the printing heads.

The advantage of the rotary printing press according to the invention is its high degree of versatility. In addition, the time required for a job change is extremely short. The favorable ergonomic configuration provides fast and easy access to the printing cylinder.

Other features which are considered as characteristic for the invention are set forth in the appended claims.

Although the invention is illustrated and described herein as embodied in a rotary printing press, it is nevertheless not intended to be limited to the details shown, since various modifications and structural changes may be made within without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is diagrammatic, perspective view of a printing platform for a standard flexographic printing process with a fixed printing cylinder and a fixed anilox roller according to the invention;

FIG. 2 is a diagrammatic, perspective view of the printing platform for the standard flexographic printing process with a drawer for the flexographic inking unit in the extended position;

FIG. 3 is a diagrammatic, perspective view of the printing platform for the standard flexographic printing process with a front plate of a printing cylinder moved downward;

FIG. 4 is a diagrammatic, perspective view of the printing platform for the standard flexographic printing process with the front plate for the anilox roller moved downward;

FIG. 5 is a diagrammatic, perspective view of the printing platform for the standard flexographic printing process with the front plates moved downward;

FIG. 6 is a diagrammatic, perspective view of a gear side of the printing platform without printing head;

FIG. 7 is a diagrammatic, perspective view of the printing platform with the printing head for the silk-screen printing process; and

FIG. 8 is a diagrammatic, perspective view of the printing platform with the printing head for the silk-screen printing process.

### DESCRIPTION OF THE PREFERRED EMBODIMENTS

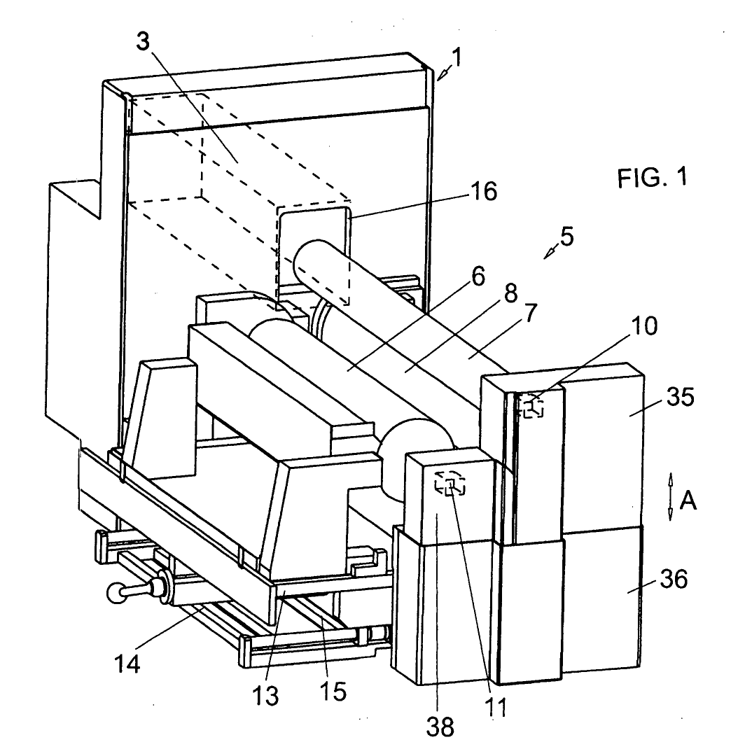

Referring now to the figures of the drawing in detail and first, particularly, to FIG. 1 thereof, there is shown a perspective view of a printing platform 1 with a printing head 5 for a standard flexographic printing process. The elements that are shown are a printing cylinder 7, an anilox roller 6, and an impression cylinder 8. A transport roller 17 and a guide roller 18 are provided for transporting a non-illustrated print substrate.

The printing cylinder 7 is driven by a servomotor 3. The printing cylinder 7 carries a non-illustrated sleeve, to which air is applied, thus causing the sleeve to expand. Compressed air for the expansion of the sleeve is supplied by the servomotor 3.

In accordance with the invention, the servomotor 3 directly drives the printing cylinder 7. The printing cylinder 7 is mounted directly to the servomotor 3 via a non-illustrated hollow shank cone.

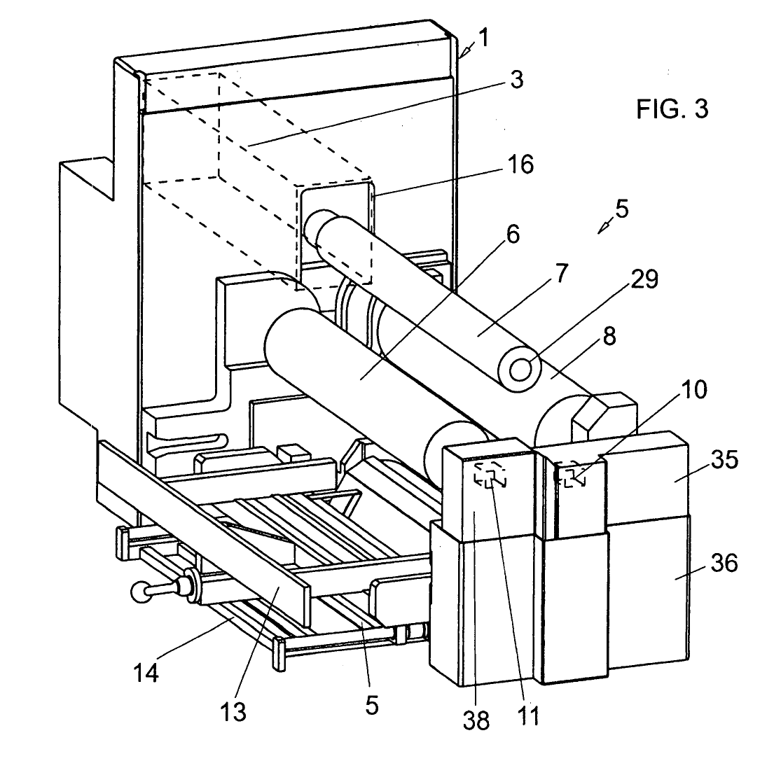

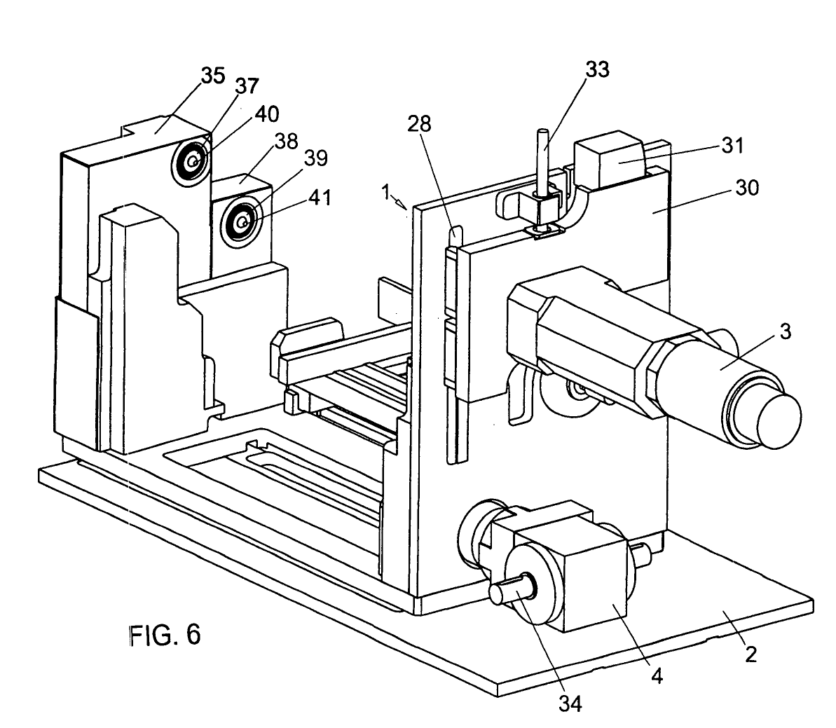

The printing cylinder 7 is mounted in a work side bearing 37 (shown in FIG. 6), which is disposed in a front plate 35. The front plate 35 is retractable in a housing 36 in the direction of the arrow A (FIG. 1). Once the bearing of the printing cylinder 7 has been released, the front plate 35 is lowered (FIG. 3). A pneumatic cylinder 10 is provided for releasing and locking the cylinder 7 in the bearing. In the lowered position, the printing cylinder 7 is freely accessible from the work side.

Another work side bearing 39 (shown in FIG. 6) of the anilox roller 6 is supported in another front plate 38. The bearing 39 is also controlled by a pneumatic cylinder 11.

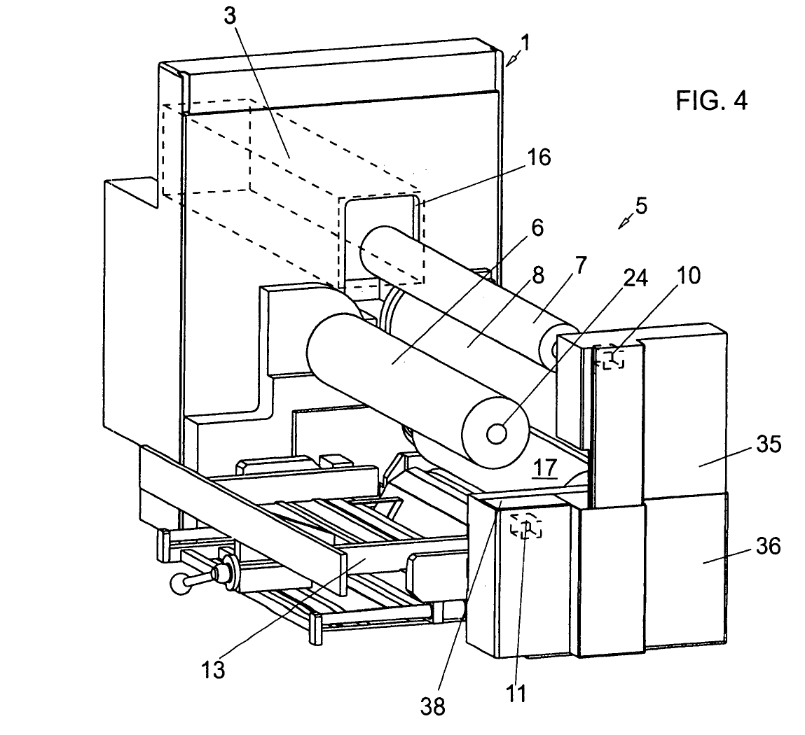

The front plate 38 can also be lowered in the housing 36 to release the anilox roller 6 (FIG. 4).

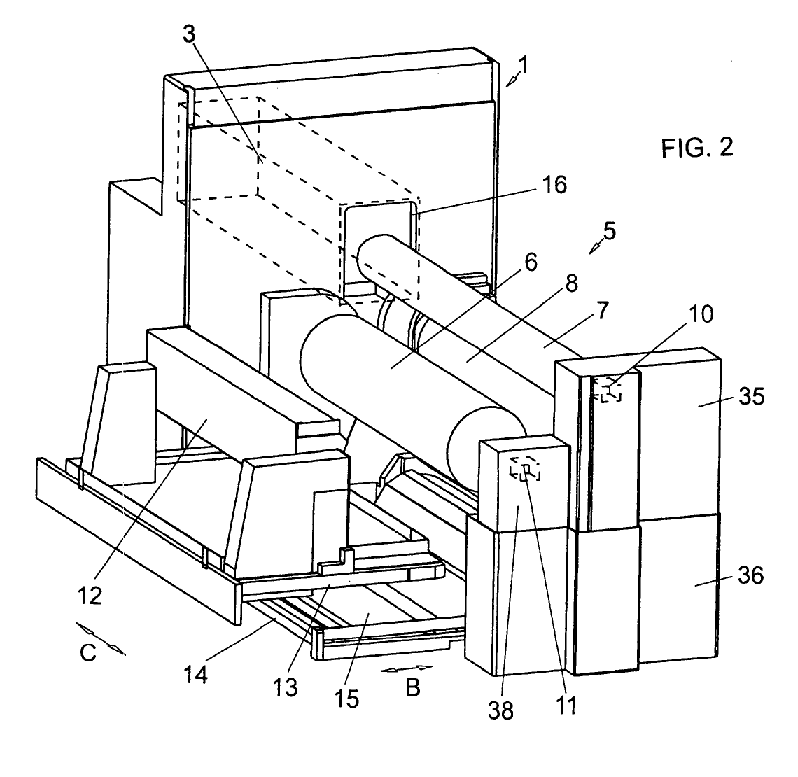

FIG. 2 shows the printing platform 1 with the printing head 5. An ink chamber 12 is disposed on a drawer system 13, which is shown in FIG. 2 in the extended position.

The ink chamber 12 applies ink to the anilox roller 6. The ink chamber 12 is inserted into and subsequently locked in the printing platform via the drawer system 13 shown in FIG. 2. The drawer system 13 includes cylindrical rails 14, 15, which permit a movement of the ink chamber 12 in the direction of arrow B. The rails 14, 15 can be extended in a telescope-like way. Subsequently, the ink chamber 12 and, as described below, the printing head for the silk-screen printing process can be moved in the direction of arrow C via another rail system, so that the printing head 5 or the ink chamber 12 can be replaced easily from the printing platform 1.

The printing cylinder 7 shown in the drawings does not yet carry the printing plate (which in turn carries the actual pattern to be printed). The printing cylinder 7 is supplied with ink by the anilox roller 6 and prints on a non-illustrated web of material passing between the printing plate 7 and an impression cylinder 8.

FIG. 3 shows the printing platform 1 with a lowered front plate 35. A bearing pin 29 is disposed in the printing cylinder 7.

In FIG. 3, the printing platform 1 is shown from the work side. The printing platform 1 still includes the printing head 5 for the standard flexographic printing process.

The adjustment of the rollers 6, 7, 8 is done via the front plates 35, 38 and the housing 36. The front plates 35, 38 are mounted so as to be movable in the direction of the arrow A. The pneumatic cylinders 10, 11 are disposed in the front plates 35, 38. The pneumatic cylinders release the rollers 6, 7 for replacement.

The printing platform 1 has a recess 16 for adjusting the height of the printing cylinder 7 and for aligning the printing cylinder 7.

The advantage of the device according to invention is that the printing head 5 can be replaced very quickly by another printing head. Moreover, no additional tools are necessary for such replacement. In addition, the device is very ergonomic.

FIG. 4 shows the front plate 38 in a lowered position to release the anilox roller 6. A bearing pin 24 that fits the bearing 39 (see FIG. 6) is disposed in the anilox roller 6.

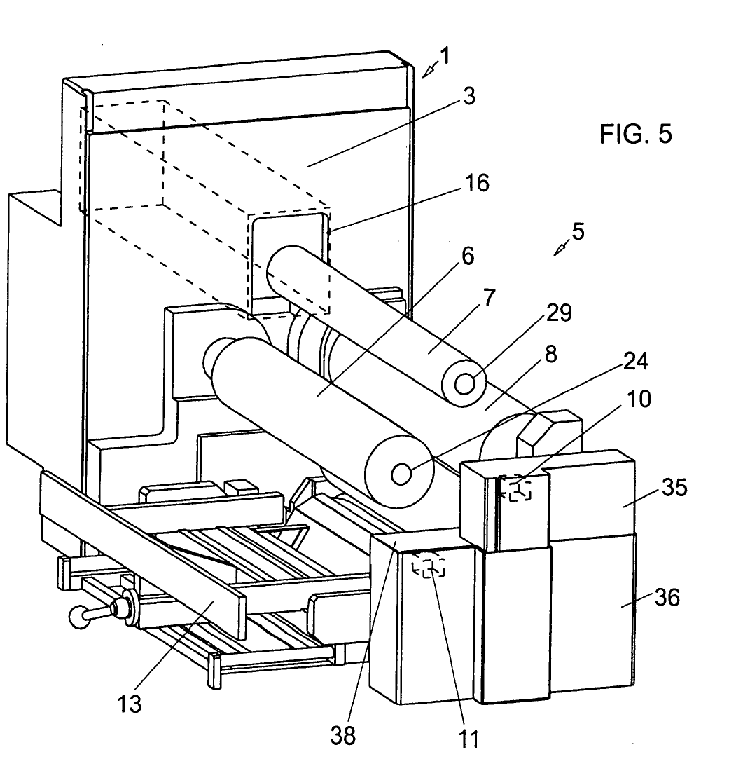

FIG. 5 shows the printing platform 1. The front plates 35, 38 have been lowered, so that the printing cylinder 7 and the anilox roller 6 can be removed comfortably.

FIG. 6 shows a gear side view of the printing platform 1 without printing heads. The printing platform 1 contains a servomotor 3 as well as a main gear box 4. The main gear box 4 drives all transport rollers that transport the web, whereas the individual printing heads are individually driven by the servomotors 3. The printing platform 1 contains perpendicular guides 28 for adjusting a plate 30. To provide alignment and adjustment of the entire device, the height of the plate 30 is adjustable via a motor 31 and a spindle 33 driven by the motor 31. In addition, the adjustability of the plate 30 makes it possible to move the printing cylinder 7, together with the front plate 35, upward out of the printing position. Subsequently, the front plate 35 is lowered, and the printing cylinder 7 is freely removable from the work side.

The transport rollers and deflection rollers are driven by the main gear box 4. The main gear box 4 has a continuous main shaft 34, which also drives further transport rollers of neighboring printing heads.

Conically tapered pins 40, 41 for fixing the printing cylinder 7 and the anilox roller 6 are disposed in the bearings 37, 39.

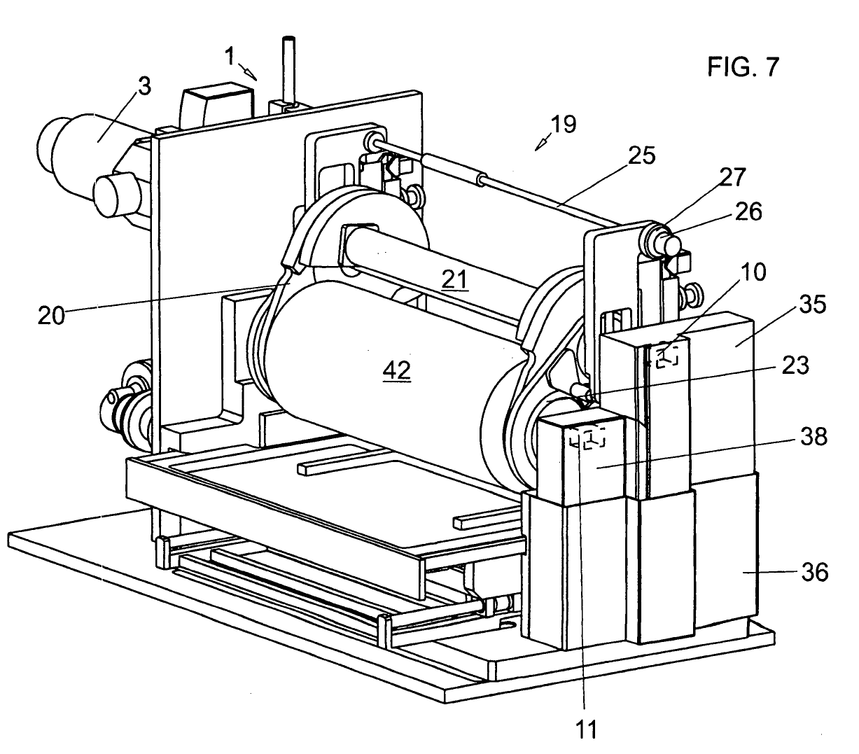

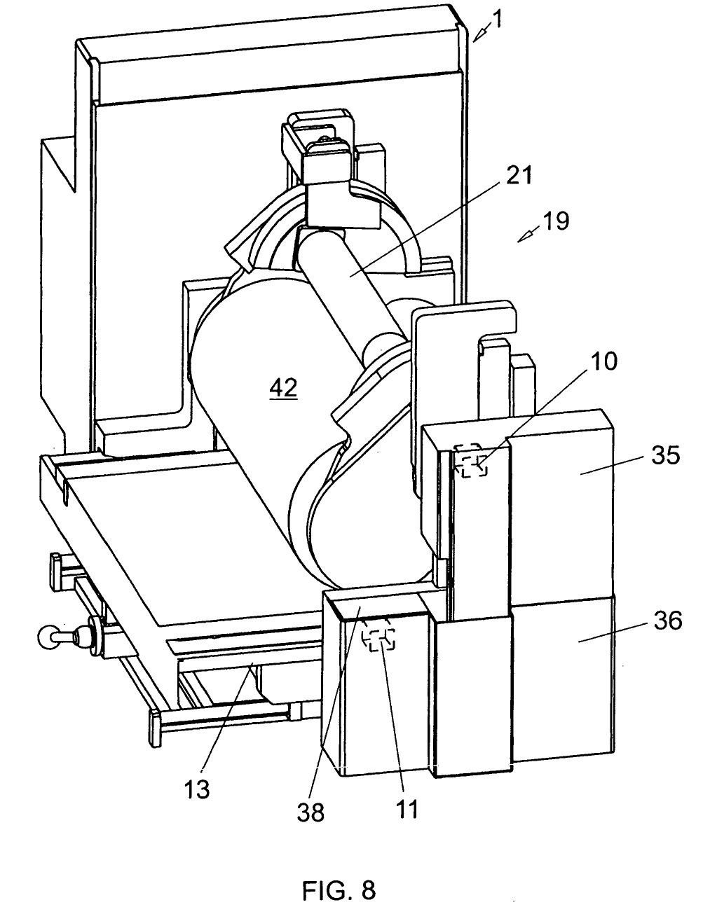

FIGS. 7 and 8 show the printing platform 1 with a printing head 19 for silk-screen printing. The transport cylinder 17 and the impression cylinder 8 (not shown because they are located behind a screen stencil 42) are the same as in FIGS. 1 to 3. These cylinders are usually not replaced when the printing heads 5, 19 are replaced.

The printing head 19 has an eyeglass-shaped element 20, which is fastened in the printing platform 1. A cylinder 21 is driven by the servomotor 3. The cylinder 21 represents a linear guide. The screen stencil 42, which is inserted into a hollow gear 23, is driven by a gear wheel 22. A non-illustrated squeegee is disposed in the screen stencil. To insert the sensitive printing head 19, the printing head 19 is compressed in the width.

Having been inserted into the printing platform 1, the printing head 19 expands so that it fits into the printing platform 1. Then the printing head 19 is locked. It is only then that the sensitive screen stencil is inserted into the hollow gear 23. Subsequently, the squeegee is inserted. The squeegee is adjusted via its fastening 24, which is coupled to an adjusting rod 25. Adjustment buttons 26, 27 are provided for adjusting the position of the squeegee. The adjustment buttons 26, 27 are configured in such a manner that the adjustment button 26 adjusts the work side part of the squeegee while the adjustment button 27 adjusts the gear side part and the fastening 24. The buttons 26, 27 can also be coupled to achieve a uniform adjustment on both sides.

The device according to the invention has the advantage that the screen printing unit 19 has a simpler configuration than the prior art screen printing units. A screen printing unit according to the invention, like the one in FIG. 7, only weighs 15 kilograms, whereas prior art printing units weigh about 250 kilograms.

We claim:

1. A rotary printing press selectively usable for different printing technologies, comprising:
a printing platform;
a printing head, selected from the group consisting of a standard flexographic printing process print head and a silk-screen printing process print head, inserted into said printing platform; and
bearings including a gear side bearing and a work side bearing for receiving a printing cylinder, said work side bearing configured for releasing the printing cylinder and to be movable out of an operating area independently of said gear side bearing.

2. The rotary printing press according to claim 1, wherein said gear side bearing is a movable bearing.

3. The rotary printing press according to claim 1, further comprising a front plate and said work side bearing is disposed in said front plate, said front plate is lowerable after release by said work side bearing.

4. The rotary printing press according to claim 1, further comprising:
a further front plate having a further work side bearing for receiving an anilox roller, said further front plate with said further work side bearing releasing the anilox roller, and said further work side bearing with said further front plate is movable out of the operating area; and
a further gear side bearing disposed on an opposite side of the anilox roller.

5. The rotary printing press according to claim 4, wherein paths of movement of said work side bearing and said further work side bearings are exclusively linear paths.

6. The rotary printing press according to claim 4, further comprising ball spindle drives for moving at least one of said work side bearing, said further work side bearing, said front plate and said further front plate.

7. The rotary printing press according to claim 6, further comprising positioning drives driving said ball spindle drives.

8. The rotary printing press according to claim 4, wherein after removal of the printing cylinder and the anilox roller, said silk-screen printing process print head is utilizable in the rotary printing press.

9. The rotary printing press according to claim 8, further comprising a drawer system for inserting and positioning said silk-screen printing process print head.

10. The rotary printing press according to claim 1, further comprising an individual drive driving said printing head.

11. The rotary printing press according to claim 1, further comprising:
at least one of drive transport rollers and ink rollers; and
a main shaft for driving said driving transport rollers and/or said ink rollers.

12. The rotary printing press according to claim 1, wherein a rotary direction of said printing cylinder is alterable.

13. The rotary printing press according to claim 8, further comprising:
an ink chamber for said standard flexographic printing process print head; and
a drawer system for inserting and positioning said ink chamber.

14. A method of providing free access to a printing cylinder in a rotary printing press, the rotary printing press containing a printing platform, a printing head, selected from the group consisting of a standard flexographic printing process print head and a silk-screen printing process print head, inserted into the printing platform, and bearings including a gear side bearing and a work side bearing for receiving the printing cylinder, the work side bearing configured to release the printing cylinder and to be movable out of an operating area independently of the gear side bearing, which comprises the steps of:
disposing the work side bearing in a front plate with the front plate being lowerable after release of the work side bearing;
moving the front plate with the work side bearing and the gear side bearing out of a printing position and that before, during and/or after a movement of the bearings, the work side bearing of the front plate releases the printing cylinder; and
subsequently moving the work side bearing with the front plate out of the operating area.

15. A method of providing free access to a printing cylinder in a rotary printing press, the rotary printing press containing a printing platform, a printing head, selected from the group consisting of a standard flexographic printing process print head and a silk-screen printing process print head, inserted into the printing platform, and bearings including a gear side bearing and a work side bearing disposed in a front plate for receiving the printing cylinder, the work side bearing configured for releasing the printing cylinder and to be movable out of an operating area independently of the gear side bearing, the rotary printing press further having a further front plate with a further work side bearing for receiving an anilox roller and a further gear side bearing disposed on an opposite side of the anilox roller, which comprises the steps of:
operating the further front plate with the further work side bearing for releasing the anilox roller;
moving the further work side bearing with the further front plate out of the operating area;
moving the work side bearing and the further work side bearing upward; and
subsequently lowering the front plate with the work side bearing and the further front plate with the further work side bearing.
